(19) United States
(12) Patent Application Publication
(10) Pub. No.: US 2001/0006139 A1
(43) Pub. Date: Jul. 5, 2001

(54) Clutch assembly of automatic transmission

(76) Inventor: Myoung-Hun Kang, Yongin-city (KR)

Correspondence Address: BIRCH, STEWART, KOLASCH & BIRCH, LLP, P.O. Box 747, Falls Church, VA, 22040-0747, US

(21) Appl. No.: 09/737,934

(22) Filed: Dec. 18, 2000

(30) Foreign Application Priority Data
Dec. 30, 1999 (KR) 99-66633

(51) Int. Cl. F16D 25/0638

(52) U.S. Cl. 192/85 AA; 192/70.28

(57) ABSTRACT

A clutch assembly of an automatic transmission includes a clutch pack mounted on a turbine shaft, a piston mounted to one end of the clutch pack for selectively depressing the clutch pack, a stopper plate fixed at the other end of the clutch pack for supporting the clutch pack, and a plurality of return springs arranged parallel with the clutch pack between the stopper plate and the piston, for returning the piston.

### BACKGROUND OF THE INVENTION

1. Field of the Invention

The present invention relates to a clutch assembly of an automatic transmission, and in particular, to a multi-plate clutch assembly capable of improving shift quality during an N→R shift as well as minimizing the size of the clutch assembly by installing return springs parallel with the clutch pack in a longitudinal direction.

2. Description of the Related Art

FIG. 1 schematically shows a conventional automatic transmission clutch assembly. The clutch assembly comprises a clutch pack of a plurality of clutch plates 4 and clutch discs 6 alternately arranged in a clutch drum 14, a snap ring 16 mounted in a distal end portion of the retainer 14 so as to contact the last clutch, and a piston 8 for depressing the clutch pack. A return spring 10 is installed in the retainer 4 for returning the piston 12.

In this clutch assembly, the return spring 10 is linearly installed in relation to the clutch pack which means that the length of the clutch assembly is increased. Furthermore, this arrangement with the return spring 10 requires additional parts such as a retainer 14 and snap ring 16, which causes greater complication in assembly and disassembly, as well as an increase in the weight of the clutch assembly.

In addition, the increase of the clutch assembly length increases instability so as to adversely effect the whole transmission, resulting in a lowered shift quality.

### SUMMARY OF THE INVENTION

The present invention has been made in an effort to solve the above problems of the prior art.

It is an object of the present invention to provide a clutch assembly capable of improving shift quality during an N→R shift as well as minimizing a full size of the clutch assembly by installing a return spring overlapping a clutch pack in a longitudinal direction.

To achieve the above object, a clutch assembly of an automatic transmission according to the present invention comprises a clutch pack mounted on a turbine shaft, a piston mounted to one end of the clutch pack for selectively depressing the clutch pack, a stopper plate fixed to the other end of the clutch pack for supporting the clutch pack, and a plurality of return springs arranged parallel with the clutch pack between the stopper plate and the piston, for returning the piston.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a side cross sectional view of a conventional clutch assembly;

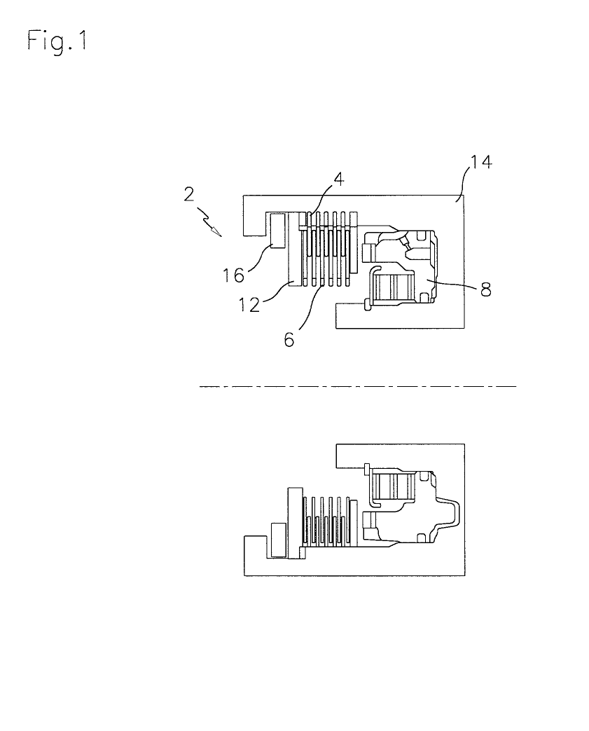

FIG. 2 is a side cross sectional view of a clutch assembly according to a preferred embodiment of the present invention; and

FIG. 3 is a perspective view of clutch plates of the clutch assembly of FIG. 2.

### DETAILED DESCRIPTION OF THE PREFERRED EMBODIMENTS

A preferred embodiment of the present invention will be described hereinafter with reference to the accompanying drawings.

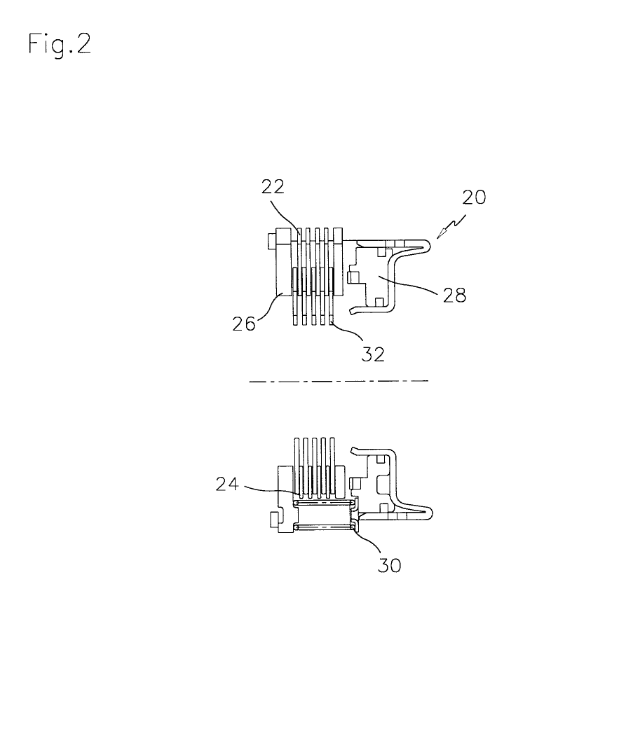

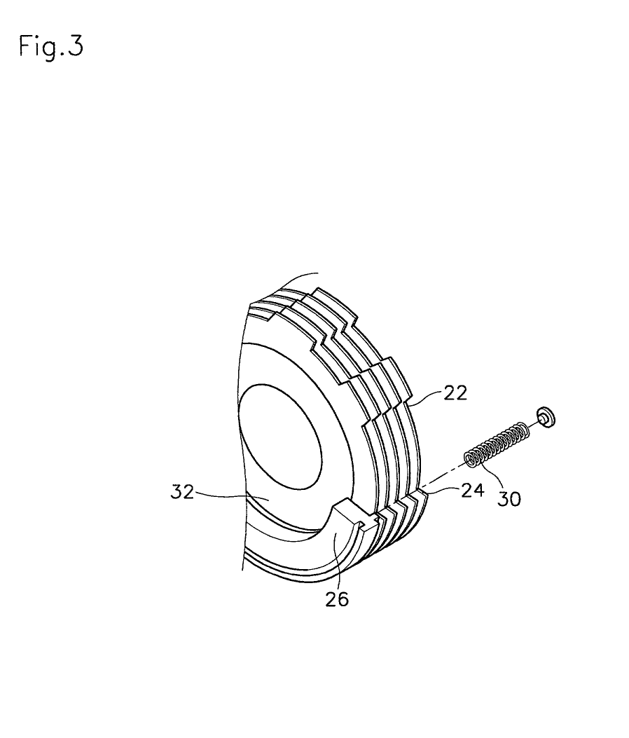

FIG. 2 and FIG. 3 are respectively a side cross sectional view and a perspective view of a clutch assembly according to a preferred embodiment of the present invention.

A clutch pack is mounted on a turbine shaft (not shown) and comprises a plurality of alternating clutch plates 22 and clutch discs 32 arranged between a stopper plate 26 and a piston 28. A plurality of return springs 30 are circurferencially installed in parallel with relation to the clutch pack.

Each clutch plate 22 has a plurality of indents 24 formed around the circumference thereof so as to form several furrows in a longitudinal direction of the clutch assembly, and each return spring 30 is located within a furrow between the stopper plate 26 and the piston 28.

In this clutch assembly, since the return springs 30 are arranged parallel with the clutch pack and are directly supported by the stopper plate 26 and the piston 28, it is possible to avoid using a clutch drum with a snap ring for supporting the return springs 30 as in the conventional clutch assembly.

The operation of the clutch assembly of the present invention is similar to the conventional clutch assembly such that if hydraulic pressure is applied to the piston by a hydraulic system (not shown), the piston 28 contacts and depresses the clutch pack so as to engage the clutch plates 22 and the clutch discs 32 to each other. On the other hand, if the hydraulic pressure is released from the piston, the piston retreats by an elastic force of the return springs 30.

As described above, in the clutch assembly of the present invention, the return springs are arranged along the furrow formed around the clutch pack in parallel such that the clutch assembly dimensions, particularly length, is minimized. Also, by eliminating additional parts such as the retainer and snap ring, the clutch assembly's weight decreases. Additionally, the simplified structure decreases whole manufacturing costs as well as improves stability and durability of the clutch assembly.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A clutch assembly of an automatic transmission comprising:
a clutch pack mounted on a turbine shaft;
a piston mounded to one end of the clutch pack for selectively depressing the clutch pack;
a stopper plate fixed at a second end of the clutch pack for supporting the clutch pack; and
a plurality of return springs arranged parallel with the clutch pack between the stopper plate and the piston to bias the piston toward an initial position.

2. A clutch assembly of claim 1 wherein the clutch pack comprises a plurality of clutch plates and clutch discs alternately arranged in a longitudinal direction of the turbine shaft.

3. A clutch assembly of claim 2 wherein each clutch plate has a plurality of indents formed around a circumference thereof.

4. A clutch assembly of claim 2 wherein the clutch pack is provided with a plurality of furrows formed by aligning the indents of the clutch plates.

5. A clutch assembly of claim 4 wherein the return springs are located within the furrows of the clutch pack.
